(19) United States
(12) Patent Application Publication
(10) Pub. No.: US 2022/0222761 A1
(43) Pub. Date: Jul. 14, 2022

(54) STUDY RIGHT LLC.

(71) Applicant: markeisha davis, LOVELAND, OH (US)

(72) Inventor: markeisha davis, LOVELAND, OH (US)

(21) Appl. No.: 17/574,415

(22) Filed: Jan. 12, 2022

Related U.S. Application Data
(60) Provisional application No. 63/136,787, filed on Jan. 13, 2021.

(51) Int. Cl. G06Q 50/20; G09B 3/10

(52) U.S. Cl. CPC G06Q 50/2053; G09B 3/10

(57) ABSTRACT

This invention is about providing a repository of study materials generated by academics who match educational criteria.

### CROSS-REFERENCE TO RELATED APPLICATIONS

This application is based on provisional application reference: 63/136,787

### BACKGROUND OF THE INVENTION

This application would improve the way many of us study, while also compensating and providing a way for students to make a way of living. A way to a better understand what is being learned not just being given the answers but utilizing available resources to improve study habits. A way to teach you how to study to look for key words to write down not just based on memory but actual understanding of any subject.

### BRIEF SUMMARY OF INVENTION

This application would provide a means of compensating students for their hard work. Many college students struggle with taking proper notes not using actual answers typed in a search bar. The actual understanding of what's to be learned. Students can earn income to assist with textbooks, meals etc. would be offered as a work study program or student employment at the university.

### DETAILED DESCRIPTION OF THE INVENTION

StudyRight LLC. Would provide a service to individuals who struggle with studying. My idea is that clients will submit a course book and/or syllabus with the correct course material of whats being studied. The idea is that they would use an APP to sign up for help with a study guide someone would create and write up notes for them to study a chapter or several chapters if need be. The person who signs up to create the study guide for this person to study from would have to meet certain G.P.A requirements. A student could request a study guide from any subject. Math, Science etc. My idea is to connect with the school to make this a work study option or just an option for a student to earn some extra cash, for those who meet the requirements. This would not be a way for clients to get out of creating notes on their own, but it would help those who struggle with taking proper notes. There will be no answers given to any exams or quizzes. Study guides will include material for individual chapters or exams. The price will vary depending on the clients need. There will be a set price per chapter or the entire chapters for that course based on the syllabus or just an idea of what chapters the course will cover. Notes can be given in any form that would help benefit the student or client.

StudyRight LLC. Would provide a service to individuals who struggle with studying. My idea is that clients will submit a course book and/or syllabus with the correct course material of whats being studied. The idea is that they would use an APP to sign up for help with a study guide someone would create and write up notes for them to study a chapter or several chapters if need be. The person who signs up to create the study guide for this person to study from would have to meet certain G.P.A requirements. A student could request a study guide from any subject. Math, Science etc. My idea is to connect with the school to make this a work study option or just an option for a student to earn some extra cash, for those who meet the requirements. This would not be a way for clients to get out of creating notes on their own, but it would help those who struggle with taking proper notes. There will be no answers given to any exams or quizzes. Study guides will include material for individual chapters or exams. The price will vary depending on the clients need. There will be a set price per chapter or the entire chapters for that course based on the syllabus or just an idea of what chapters the course will cover. Notes can be given in any form that would help benefit the student or client.

1. A repository of study materials generated by academics who match educational criteria.
